(19) United States
(12) Patent Application Publication
(10) Pub. No.: US 2007/0045195 A1
(43) Pub. Date: Mar. 1, 2007

(54) System and method for cleaning a petroleum spill from water, and for recovering petroleum from spill

(76) Inventor: Charles T. Chick, Pleasant Hill, MO (US)

Correspondence Address: DAVID E. HERRON II, PO BOX 2778, KANSAS CITY, KS, 66110, US

(21) Appl. No.: 11/513,453

(22) Filed: Aug. 31, 2006

Related U.S. Application Data
(60) Provisional application No. 60/765,422, filed on Feb. 3, 2006.
(60) Provisional application No. 60/712,379, filed on Aug. 31, 2005.

(51) Int. Cl. B01F 13/02

(52) U.S. Cl. 210/747; 210/767; 366/101

(57) ABSTRACT

The disclosure presents and depicts a method for removing petroleum product from water in an area of a petroleum spill. The disclosure also depicts a system for removing petroleum product from water in an area of a petroleum spill.

### BACKGROUND AND FIELD OF THE INVENTION

Spills of petroleum product into bodies of water present numerous dangers to the environment, fish, and wildlife. Moreover, these same spills require the disposal and waste of large amounts of petroleum. The invention assists in cleaning petroleum spills from bodies of water, and further enables the recapture and use of the petroleum product, thereby reducing the waste of this scarce and expensive resource.

### SUMMARY OF THE INVENTION

The invention is a system and a method for removing petroleum product from water in an area of a petroleum spill, and for recapturing the petroleum to prevent its waste. The entire content of provisional application 60/765,422 and 60/712,379 are each incorporated herein by reference as if set forth verbatim herein.

### The Inventive Method

The inventive method includes the steps of the steps of grinding rubber into crumbs. Preferably the crumb rubber is made by grinding scrap tires into a sand-like crumb product. The crumbs are placed into a vessel, and a tube connected with the vessel is inserted into the area of the petroleum spill.

The inventive method also includes the step of pumping water and petroleum mix through the tube and into the vessel, where the mix filtersx through the crumbs, then is discharged from the vessel.

The inventive method may also include the step of positioning a positioning a discharge orifice on the vessel, and placing a screen that substantially prevents the crumbs from passing through the orifice. In another embodiment of the inventive method, the vessel has a first portion and a second portion. With this version, the filtering step includes the step of introducing the mixture into the first portion, and the discharging step includes the step of expelling the filtered mix from the second portion.

Additionally, the method may include the steps of positioning a hose to connect the first portion of the vessel to its second portion. In this version, the filtering step includes the steps of sucking the mix into the first portion of the vessel, urging the mix from the first portion and into the second portion by means of the hose. Further, this version will require the mix to be expelled from the second portion of the vessel.

Further, the above version may be supplemented by creating the vessel to have a third portion. Analogously, this improvement will have a second hose connecting the second and third portions of the vessel so that the filtering step will include the steps of discharging the mix from the second portion, through the second connecting hose and into the portion of the vessel. The mix is then discharged from third portion of the vessel.

In preferred embodiments of the method, the crumbs are no finer than 30 mesh, and have a specific gravity of no greater than 1; preferably, the crumbs have a specific gravity in the range of 0.5 to 0.75.

In another preferred embodiment of the inventive method, the second portion of the vessel is situated lower than the first portion of the vessel. In like manner, a third portion (if applicable) of the vessel is lower than the second portion of the vessel. This configuration allows the weight of the mix to urge it downwardly through each of the portions of the vessel.

Optionally, the vessel may be divided into first, second (and maybe third) chambers that are positioned within an interior portion of the vessel. In this embodiment, the first chamber positioned adjacent an upper end of the vessel, and a second chamber positioned beneath the first chamber. The third chamber (if applicable), is positioned beneath the other two portions. In this embodiment, the method includes separating the first chamber from the second chamber by a screen having a mesh that substantially prevents the crumbs from passing therethrough. Additionally, the method will include step of placing a portion of the crumbs in each chamber of the vessel; and expelling the mix from the vessel after passing through the second chamber.

In like manner, the vessel may also include a third chamber positioned beneath the second chamber. Further, the method may include the step of separating the second chamber from the third chamber by a second screen having a mesh that substantially prevents the crumbs from passing therethrough, and then expelling the mix from the vessel after passing through the third chamber.

Once the mix has filtered through and the water has substantially been expelled from the vessel, the petroleum product may be extracted from the crumbs by any known means, such as by a centrifuge, a roller, a press, or any known squeezing means.

### The Inventive System

The invention is also system for removing petroleum product from water in an area of a petroleum spill. The system includes rubber ground into crumbs and placed into a vessel, and a tube with a first end being insertable into the area of the petroleum spill, and a second end connected to the vessel.

A pump is connected to the tube and urges a mix of petroleum and water through the tube and into the vessel. which has an outlet/discharge orifice. The petroleum product is filtered from the mix by passing through the crumbs, and filtered mix is discharged from the orifice.

The inventive system may also incorporate a screen positioned adjacent the orifice and having a mesh that substantially retains the crumbs within the vessel but allows the filtered mix to escape the orifice.

Optionally, the vessel may have a first portion and a second portion. The mix is filtered by being introduced into the first portion, then entering the second portion and being expelled from the vessel after passing through the second portion. A hose may link the first portion to the second portion. In this version of the system, the mix is filtered by sucking the mix into the first portion of the vessel, then urging the mix from the first portion, through the hose, and into the second portion, then and discharging the mix from the second portion of the vessel. Analogously, the vessel may have a third portion, and the mix is filtered through the third portion after it passes through the second portion. Then, the mix is discharged from third portion of the vessel. A second hose may connect the second and third chambers as well.

Instead of being divided into discreet portions linked by hose(s), the vessel may be divided into chambers within the interior of the vessel. Each successive chamber is preferably situated below the next, thereby enabling the weight of the mix to act as an urging force that directs the mix through each successive chamber.

In preferred embodiments, the crumbs have a specific gravity of less than 1, and preferably in the range of 0.5 to 0.75, and are no finer than 30 mesh. Optionally, the crumbs may be pre-treated with a hydrophobic, adsorbent oleophilic compound. Once the mix has been expelled from the vessel, the system may include an extractor (such as a pump, centrifuge, roller, press, or any known mechanical squeezer) for removing petroleum product from the crumbs. Once removed from the crumbs, the petroleum product may be refined, filtered, and/or re-used.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view showing a first embodiment the inventive system and method, according to the principles of the invention.

FIG. 2 is a perspective view showing a second embodiment of the invention.

FIG. 3 is a perspective and cross-sectional view showing the details of the vessel and its content.

FIG. 4 shows a centrifugal extractor removing the petroleum product from the crumbs.

### DETAILED DESCRIPTION OF THE PREFERRED EMBODIMENTS

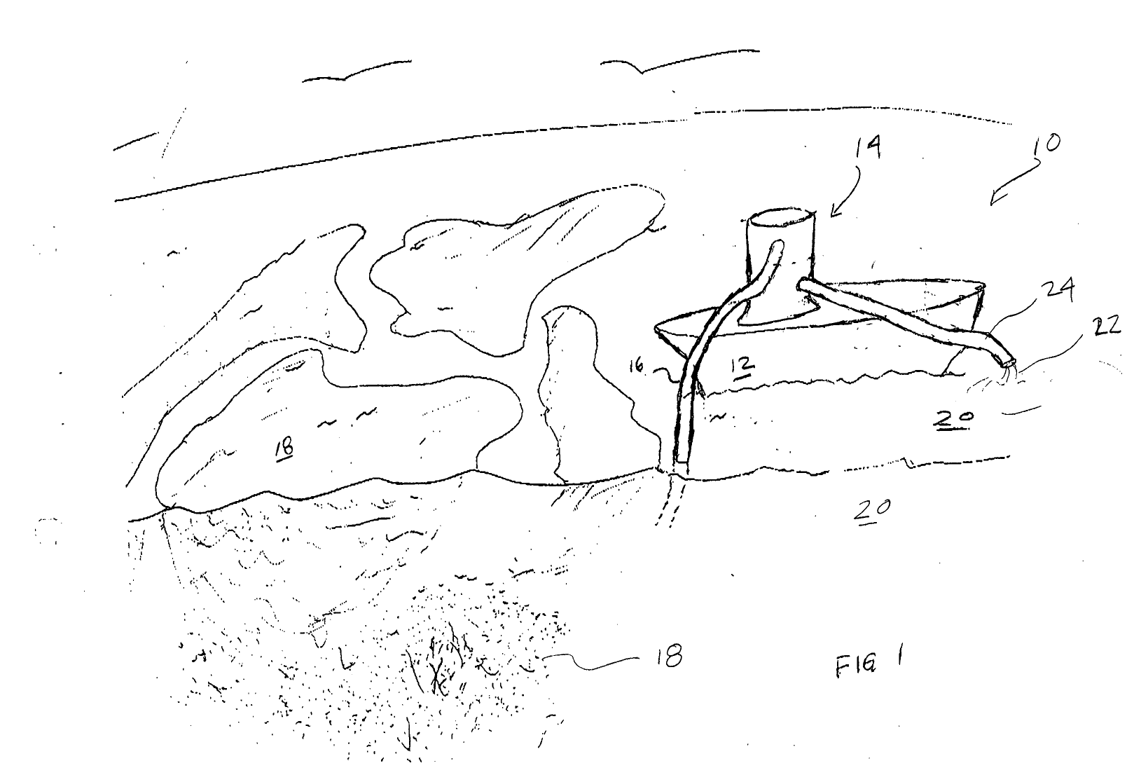

FIG. 1 is a perspective view showing a first embodiment the inventive system method, according to the principles of the invention. The system 10 includes a vessel 14 on the deck of a ship 12, and a tube 16 extending from the vessel and into the body of water 20. As shown, the water 20 is polluted with the spill of a petroleum product 18 such as oil, gasoline, or diesel, for example.

Still referring to FIG. 1, the tube 16 is inserted into the water 20 in the area of the petroleum product 18. A pump or suction device (not shown) then urges the mixer of water 20 and petroleum 18 into the vessel 14, preferably at an upper portion of the vessel 14. While the mixture (petrol 18 and water 20) is within the vessel, it filters through crumb rubber (not shown in FIG. 1, but shown aft), and exits from the vessel 14 and is expelled from hose 24. The system 10 then expels a cleaner product 22 (with most of the petroleum 18 removed) back into the body of water.

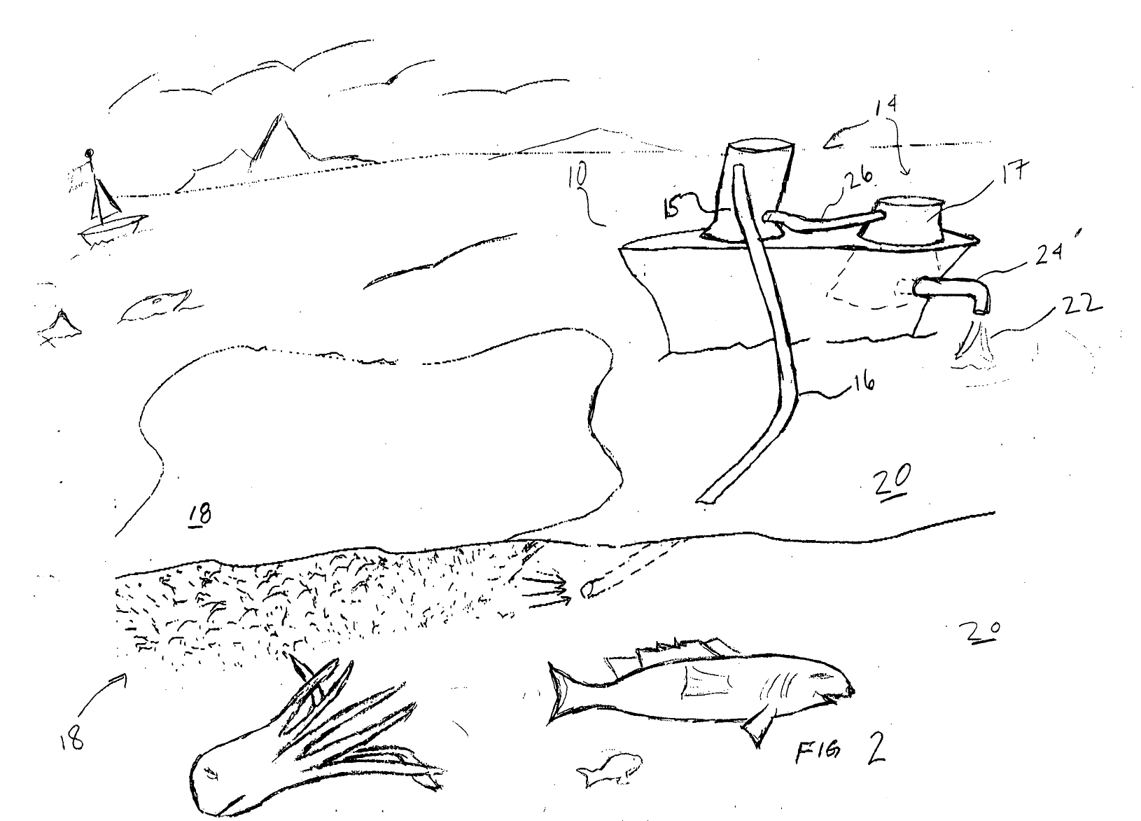

FIG. 2 shows a second embodiment of the inventive system 10. In this embodiment the vessel 14 comprises a first portion 15 connected to a second portion 17 by a connecting hose 26. Structurally, the first 15 and second 17 portions are analogous; however, note that the tube 16 connects to the first portion 15 near its upper, and connecting hose 26 emanates from a lower section of the first portion 15. This configuration enables the weight of the mix (18&20) to compel itself downwardly so that the mix (18&20) exits via connecting hose 26, and enters the second portion 17.

Still referring to FIG. 2, the second portion 17 is positioned lower than the upper portion 15. In this drawing, the second portion actually extends below the deck of the ship 12, but this is not required. It is preferred, however, that the first portion 15 be above the second portion 17 so that the weight of the content of the vessel 14 urges the mixture from the first 15 to the second 17 portion, then after passing through the second portion, cleaner liquid 22 (with the petroleum 18 substantially removed) is expelled from outlet 24 back into the water 20.

The embodiment in FIG. 2 allows the mixture (18&20) to endure two separate filtering processes; if any petroleum 18 remains in the mixture (18&20) after passing through the first portion 15 of the vessel 14, the petroleum 18 concentration of the mixture (18&20) can be further reduced by introducing it into the second portion 17 where it is filtered again. In like manner the vessel 14 may include third (or subsequent) portions (not shown) in order to further reduce the petroleum concentration of the mixture.

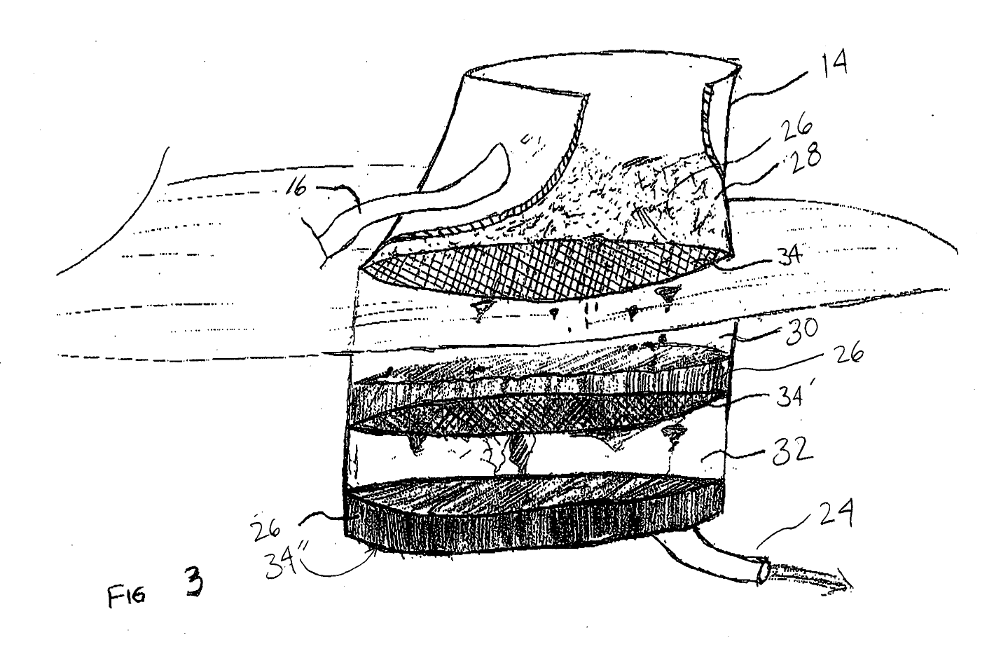

FIG. 3 shows a cut-out, cross-sectional view of another embodiment of the vessel 14. In this embodiment, the vessel 14 comprises a single vessel having a plurality of chambers within its interior. As shown, the vessel 14 comprises a first chamber 28 located in an upper region of the vessel 14, and a second chamber 30 positioned below the first chamber 28.

FIG. 3 also shows a third chamber 32 positioned beneath the second chamber 30. Of course, additional chambers may be selectively added (or subtracted) in order to adjust the amount of filtering that is required. The first chamber 28 has a screen 34 at its bottom end, and crumbs 26 rest atop the screen 34. It is preferred that the size of the crumbs 26 in the first chamber 28 be generally unable to pass through the mesh of the screen 34.

Still referring to FIG. 3, the second chamber 30 is positioned beneath the first chamber 28. The second chamber 30 also includes rubber crumbs 26 that rest atop a screen 34′ positioned at the bottom of the second chamber 30. Again, it is important that the size of the crumbs 26 in the second chamber 30 be chosen so that the crumbs 26 cannot pass through the screen 24′. A third chamber 32 is positioned beneath the second chamber 30, and also contains rubber crumbs 26 that rest atop a screen 34″ adjacent the bottom of the vessel 14. The outlet hose 24 (see also, FIGS. 1 and 2) then discharges the mix 18 after it passes through the vessel 14.

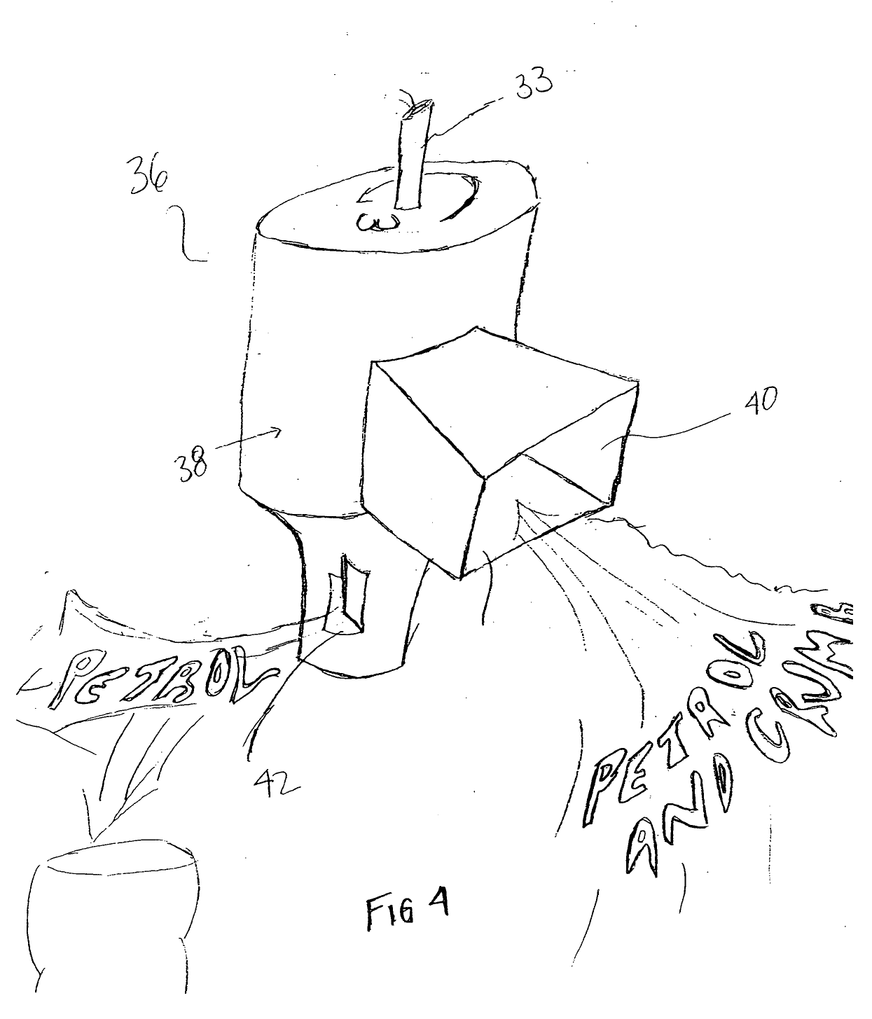

FIG. 4 shows a common extractor that can be used to remove the petroleum product 20 from the combination of petroleum 18 and crumb 26. FIG. 4 depicts a centrifuge-type extractor 36 wherein petroleum and crumbs enter the body 38 of the extractor 36 via inlet 40. Once inside the body of the extractor, an axis 33 imparts angular rotation ω to the content of the extractor 36. Once the petroleum 18 has been separated from the combination, it is urged out outlet 42 where it can be placed in containers, re-fined and/or re-used.

In yet another preferred embodiment of the invention the extractor 36 and the vessel 14 (as shown in FIG. 3) may be one-and-the same. To wit, the vessel 14 may not only comprise numerous chambers, it may also double as a centrifuge which, after filtering water 20 from the mix (18&20), the extractor 36 may then be activated within the vessel 14 so that the petroleum can be removed from the rubber crumbs 26.

Although the present invention has been described and illustrated in detail, it is to be clearly understood that the same is by way of illustration and example only, and is not to be taken by way of limitation. The spirit and scope of the present invention are to be limited only by the terms claims that will precisely define the metes and bounds of the invention.

I claim:

1. A method removing petroleum product from water in an area of a petroleum spill, the method comprising the steps of
grinding rubber into crumbs;
placing the crumbs into a vessel;
providing a tube with a first end being insertable into the area of the petroleum spill, and a second end connected to the vessel;
inserting a tube into the area of the petroleum spill;
pumping water and petroleum mix through the tube and into the vessel;
filtering the mix through the crumbs in the vessel;
discharging the filtered mix from the vessel.

2. The method as in claim 1, wherein the discharging step includes the steps of:
positioning a discharge orifice on the vessel; and,
placing a screen having a mesh that substantially prevents the crumbs from passing therethrough.

3. The method as in claim 1, further comprising the step of
creating the vessel to have an first portion and a second portion; and, the filtering step includes the step of introducing the mixture into the first portion, and the discharging step includes the step of expelling the filtered mix from the second portion.

4. The method as in claim 3, further comprising the steps of
connecting a hose at its first end to the first portion of the vessel; and,
connecting the hose at its second end to the second portion of the vessel; and wherein,
the filtering step includes the steps of
sucking the mix into the first portion of the vessel;
urging the mix from the first portion and into the second portion by means of the hose;
and, discharging the mix from the second portion of the vessel.

5. The method as in claim 4, further comprising the step of
creating the vessel to have a third portion; and,
connecting the second portion to the third portion with a second connecting hose; and,
the filtering step includes the steps of
discharging the mix from the second portion, through the second connecting hose and into the third portion of the vessel; and,
and wherein,
the mix is discharged from third portion of the vessel.

6. The method as in claim 1, wherein the crumbs are no finer than 30 mesh.

7. The method as in claim 4, further comprising the step of positioning the second portion of the vessel lower than the first portion of the vessel.

8. The method as in claim 5, further comprising the step of positioning the third portion of the vessel lower than the second portion of the vessel.

9. The method as in claim 1, wherein the crumbs have a specific gravity of less than 1.

10. The method as in claim 9, wherein the crumbs have a specific gravity in the range of 0.5 to 0.75.

11. The method as in claim 1, further comprising the step of treating the crumbs with a hydrophobic and adsorbent oleophilic compound.

12. The method as in claim 1, further comprising the steps of
dividing the vessel into a first chamber positioned adjacent an upper end of the vessel, and a second chamber positioned beneath the first chamber;
separating the first chamber from the second chamber by a screen having a mesh that substantially prevents the crumbs from passing therethrough;
placing a portion of the crumbs in each chamber of the vessel; and,
expelling the mix from the vessel after passing through the second chamber.

13. The method as in claim 12, further comprising the steps of
dividing the vessel to include a third chamber positioned beneath the second chamber;
separating the second chamber from the third chamber by a second screen having a mesh that substantially prevents the crumbs from passing therethrough; and,
expelling the mix from the vessel after passing through the third chamber.

14. The method as in claim 1, further comprising the step of extracting the petroleum product adsorbed by the crumbs.

15. A system for removing petroleum product from water in an area of a petroleum spill, the system including:
rubber ground into crumbs and placed into a vessel;
a tube with a first end being insertable into the area of the petroleum spill, and a second end connected to the vessel;
a pump connected to the tube and configured to urge a mix of petroleum and water through the tube and into the vessel;
a discharge orifice positioned on the vessel; wherein,
the petroleum product is filtered from the mix by passing through the crumbs, and filtered mix is discharged from an orifice in the vessel.

16. The system as in claim 15, further including
a screen positioned adjacent the orifice and having a mesh that substantially prevents the crumbs from passing therethrough.

17. The system as in claim 15, further comprising
a first portion and a second portion of the vessel; and, wherein
the mix filters through the vessel by being introduced into the first portion, then entering the second portion.

18. The system as in claim 17, further comprising
a hose connecting the first portion of the vessel to the second portion of the vessel; and wherein,
the mix is filtered by sucking the mix into the first portion of the vessel, and urging the mix from the first portion and into the second portion by means of the hose, and discharging the mix from the second portion of the vessel.

19. The system as in claim 18, further comprising
a third portion of the vessel; wherein
the mix is filtered by
passing the mix from the second portion and into the third portion of the vessel; and,
and wherein,
the mix is discharged from third portion of the vessel.

20. The system as in claim 18, wherein the first and second portions of the vessels are chambers within the interior of the vessel.
